(19) United States
(12) Patent Application Publication
(10) Pub. No.: US 2024/0419057 A1
(43) Pub. Date: Dec. 19, 2024

(54) HIDDEN BIDIRECTIONAL ROTARY CAMERA WITH TEMPERATURE AND HUMIDITY SENSING FUNCTION

(71) Applicant: Hangzhou Meari Technology Co.,Ltd., Hangzhou (CN)

(72) Inventors: Xuefei Zhan, Hangzhou (CN); Chao Qin, Hangzhou (CN); Hongli Ying, Hangzhou (CN)

(21) Appl. No.: 18/743,575

(22) Filed: Jun. 14, 2024

(30) Foreign Application Priority Data
Jun. 16, 2023 (CN) 202321555806.8

(51) Int. Cl. G03B 17/56; G03B 17/02; H02K 7/00; H02K 11/25; H02K 37/00

(52) U.S. Cl. CPC G03B 17/561; G03B 17/02; H02K 7/003; H02K 11/25; H02K 37/00; G03B 2217/002; H02K 2211/03

(57) ABSTRACT

The invention relates to the technical field of cameras, discloses a hidden bidirectional rotary camera with a temperature and humidity sensing function. The camera includes a ball-head shell; a vertical stepping motor and a motor bracket are arranged in the ball-head shell; a first ear pad and a first motor shaft are arranged on the vertical stepping motor; a vertical shaft sleeve is arranged on the motor bracket; the first motor shaft is fixedly connected to the vertical shaft sleeve through a machine screw; the hidden bidirectional rotary camera further includes a base shell; a horizontal stepping motor is arranged in the base shell; a second ear pad and a second motor shaft are arranged on the horizontal stepping motor; a horizontal shaft sleeve is further arranged at the bottom of the motor bracket; the second motor shaft is fixedly connected to the horizontal shaft sleeve through a machine screw.

### CROSS-REFERENCE TO RELATED APPLICATIONS

This application claims priority to Chinese Patent Application No. 202321555806.8, filed on Jun. 16, 2023, which is hereby incorporated by reference in its entirety.

### TECHNICAL FIELD

The present disclosure relates to the technical field of cameras, and particularly relates to a hidden bidirectional rotary camera with a temperature and humidity sensing function.

### BACKGROUND

Existing cameras are basically characterized in that a ball-head part only realizes an up-down angle rotation function under the control of a motor, a base part and a ball-head realize a left-right rotation function together, and the ball-head part needs to be wrapped with a shell, so that a motor shaft may be fixed to the shell to realize the up-down rotation function of the ball-head. Although such solution realizes the up-down and left-right rotation function of the camera, but also has the following defects: 1, the appearance is limited, namely, the ball-head part needs to be wrapped with the shell, and the ball-head part needs to rotate at an angle up and down by taking the shell as a rotary supporting point, so the appearance cannot be diversified; 2, a necessary component of the shell is added, so the product cost is increased; and 3, vertical and horizontal rotation motion of only the ball-head part cannot be realized.

According to this solution, the overall shape of the streamline of the base in design is more similar to that of baby products. The appearance design of a traditional ball-head machine structure is abandoned, and horizontal and vertical rotation angles are realized on one ball-head. The traditional ball-head machine can only realize vertical rotation of the ball-head, and horizontal rotation can be realized only by combining the base and the ball-head.

Moreover, a temperature and humidity sensing module of the existing camera product needs to be separated from the camera, so as to better contact and sense the temperature and humidity of the external air; and although the temperature and humidity of the external air can be sensed through such solution, but it has the following defects: 1, the appearance is limited, an independent temperature and humidity sensing module needs to be made, which is not matched with the shape of the camera product; and 2, a shell needs to be additionally arranged to wrap the temperature and humidity sensor when the independent temperature and humidity sensing module is made, which causes the increase of the product cost.

The application number CN201710566376.2 discloses a camera; a horizontal rotating mechanism is arranged in a base of the camera; a main body is connected to a rotating shaft of the horizontal rotating mechanism, so that the main body may rotate in the horizontal direction; a vertical rotating mechanism and a camera assembly are arranged in a ball-head, and the ball-head is rotationally connected to the body; and the ball-head is fixed in a ball-head cavity through a rotating shaft of the vertical rotating mechanism, so that the ball-head vertically rotates in the ball-head cavity. According to the above patent, only vertical rotation of the ball-head can be realized, and horizontal rotation can be realized only by combining the base and the ball-head, which causes the limitation on the appearance and the increase of the product cost.

The utility model patent with the application number CN201621456808.1 discloses a household multi-functional network monitoring camera based on safety; and a temperature and humidity sensor of the camera is arranged on the side surface of a base and is in direct contact with external air, so that the structural volume of the base is increased, the shape of the base is limited, and the manufacturing cost of the camera is increased.

### SUMMARY

The present disclosure provides a hidden bidirectional rotary camera with a temperature and humidity sensing function, aiming to solve the defects in related technologies.

In order to solve the above technical problems, the present disclosure provides the following technical solutions:

A hidden bidirectional rotary camera with a temperature and humidity sensing function includes a ball-head shell; a vertical stepping motor and a motor bracket are arranged in the ball-head shell; the ball-head shell includes a left shell and a right shell, and the left shell is connected to the right shell; a first ear pad and a first motor shaft are arranged on the vertical stepping motor; the first ear pad is fixed to the left shell through two pan head screws; a vertical shaft sleeve is arranged on the motor bracket; the first motor shaft is fixedly connected to the vertical shaft sleeve through a machine screw; the hidden bidirectional rotary camera further includes a base shell; the ball-head shell is arranged on the upper side of the base shell; a horizontal stepping motor is arranged in the base shell; a second ear pad and a second motor shaft are arranged on the horizontal stepping motor; the second ear pad is fixed to the base shell through two pan head screws; a horizontal shaft sleeve is further arranged at the bottom of the motor bracket; and the second motor shaft is fixedly connected to the horizontal shaft sleeve through a machine screw.

Preferably, a key hole is formed in the bottom of the base shell; a key shell is arranged in the key hole; the key shell is connected to the base shell; a key PCB is arranged at the key hole in the base shell; the key PCB is fixed to the base shell through two self-tapping screws; and a temperature and humidity sensor and a key electronic component are arranged on one surface, facing the key hole, of the key PCB. The key PCB is fixed through the self-tapping screws to close a device cavity into two parts, and an internal cavity of a device is isolated from an external air cavity into two parts, so that the influence of air temperature and humidity of the internal cavity of the device on the sensing judgment of the temperature and humidity sensor is avoided.

Preferably, key shell buckles and key positioning columns are arranged on the key shell; the key positioning columns are positioned on the inner sides of the key shell buckles; the key shell is connected to the base shell through the key shell buckles; a key baffle is arranged in the key shell; the key baffle is inserted into the key shell through the key positioning columns; and the key baffle abuts against the key shell buckles. The key shell buckles on the key shell are fixed to a shell body, and the key baffle is inserted into the key shell by guiding the key positioning columns and simultaneously abuts against three key shell buckles, so that the buckles cannot deform and retreat, and then keys are fixed to the shell body and cannot be easily pulled outwards to fall off.

Preferably, grooves are formed in the outer wall of the key baffle, and the key baffle is inserted into the key positioning columns through the grooves.

Preferably, a circular hole is formed in the center of the key baffle; a spring is arranged in the center of the key shell in a sleeving manner; and one end of the spring abuts against the key shell, and the other end of the spring penetrates through the circular hole and abuts against the center of the key electronic component.

Preferably, the key PCB is positioned in the base shell to form a closed cavity; a circulation cavity is formed among the key PCB, the key shell and the base shell; an air circulation channel is formed between the key shell and the hole wall of the key hole; and the circulation cavity communicates with the air circulation channel. The air circulation channel is formed in a gap between the key shell and the shell body, so that the temperature and humidity sensor in the cavity can sense the temperature and humidity of external air.

Preferably, the ball-head shell further includes a front shell, and the front shell is connected to the left shell and the right shell through structural buckles.

Preferably, the hidden bidirectional rotary camera further includes a base lower shell, and the base lower shell is fixedly connected to the base shell through screws.

According to the present disclosure, by adopting the technical solution above, the hidden bidirectional rotary camera has the remarkable technical effects that the vertical stepping motor is fixed to the left shell of the ball-head shell of the camera with two pan head screws; meanwhile, the first motor shaft is fixed to the motor bracket with one machine screw; the first motor shaft is driven to rotate to form a counter-acting force, so as to drive the ball-head to rotate in the vertical direction; the horizontal stepping motor is fixed to the base shell of the camera with the two pan head screws; meanwhile, the second motor shaft is fixed to the motor bracket by one machine screw; and the second motor shaft is driven to rotate to form an acting force, so as to drive the ball-head and the motor bracket to rotate in the horizontal direction.

Vertical rotation of the ball-head shell of the camera: A user sends a rotation instruction to the vertical stepping motor through an APP; after the vertical stepping motor acquires the instruction, the first motor shaft of the vertical stepping motor is outputted to rotate; and the vertical stepping motor is fixed to the left shell of the ball-head shell of the camera, so the first motor shaft is fixed to a vertical shaft sleeve of the motor bracket through the machine screw. The motor bracket is fixed with the second motor shaft of the horizontal stepping motor, and cannot rotate in the vertical direction, so under the counter-acting force of the first motor shaft of the vertical stepping motor, the left shell of the ball-head shell of the camera is driven to rotate in the vertical direction; and because the left shell of the ball-head shell of the camera is a part of the ball-head shell of the camera, the ball-head shell of the whole camera is driven to rotate vertically.

Horizontal rotation of the ball-head shell of the camera: A user sends a rotation instruction to the horizontal stepping motor through an APP; after the horizontal stepping motor acquires the instruction, the second motor shaft of the horizontal stepping motor is outputted to rotate; and the horizontal stepping motor is fixed to the base shell of the camera, so the second motor shaft is fixed to the horizontal shaft sleeve of the motor bracket through the machine screw. The motor bracket is also fixed with the first motor shaft of the vertical stepping motor, and the vertical stepping motor is fixed to the left shell of the ball-head shell of the camera, so the second motor shaft directly drives the motor bracket and the ball-head shell of the camera to rotate horizontally together.

The air circulation channel is formed in a gap between the key shell and the shell body, so that the temperature and humidity sensor in the cavity can sense the temperature and humidity of external air; the key PCB is fixed through the self-tapping screws to close a device cavity into two parts, and an internal cavity of a device is isolated from an external air cavity into two parts, so that the influence of air temperature and humidity of the internal in cavity of the device on the sensing judgment of the temperature and humidity sensor is avoided; the key shell buckles on the key shell are fixed to the shell body, the spring is arranged in the middle in a sleeving manner, and the key baffle is inserted into the key shell by guiding the key positioning columns and simultaneously abuts against three key shell buckles, so that the buckles cannot deform and retreat, and then keys are fixed to the shell body and cannot be easily pulled outwards to fall off; and meanwhile, the spring provides elastic force for the stroke motion of the key shell.

According to the present disclosure, the vertical and horizontal rotary motions of a ball-head part of the camera are realized through the motor bracket, and a temperature and humidity sensing structure is hidden in a key structure, so the temperature and humidity of external air can be sensed; and moreover, the shape of the camera is not limited, so the hidden bidirectional rotary camera is more diversified, is fixed reliably, and is convenient to process, and the manufacturing cost is reduced.

### BRIEF DESCRIPTION OF DRAWINGS

FIG. 1 is a schematic structural diagram according to the present disclosure;

FIG. 2 is a section structural diagram according to the present disclosure;

FIG. 3 is a schematic structural diagram of a vertical stepping motor;

FIG. 4 is a schematic structural diagram of a motor bracket;

FIG. 5 is a schematic structural diagram of a horizontal stepping motor;

FIG. 6 is a schematic diagram of an explosion structure of a key shell, a key PCB, a key baffle and a spring;

FIG. 7 is a schematic structural diagram of key shell buckles and key positioning columns;

FIG. 8 is a position schematic diagram of key shell buckles, a key baffle and key positioning columns;

FIG. 9 is a position schematic diagram of a key PCB, a key shell and a base shell;

FIG. 10 is a schematic diagram of a closed cavity, a circulation cavity and an air circulation channel; and

FIG. 11 is a schematic structural diagram of a whole camera.

The names of the parts designated by the numbers in the above figures are as follows: 1—ball-head shell; 101—left shell; 102—right shell; 103—front shell; 2—base shell; 201—key hole; 202—closed cavity; 203—circulation cavity; 204—air circulation channel; 3—vertical stepping motor; 301—first ear pad; 302—first motor shaft; 4—motor bracket; 401—vertical shaft sleeve; 402—horizontal shaft sleeve; 5—horizontal stepping motor; 501—second ear pad; 502—second motor shaft; 6—base lower shell; 7—key shell; 701—key shell buckle; 702—key positioning column; 8—key PCB; 9—temperature and humidity sensor; 10—key electronic component; 11—key baffle; 1101—groove; 1102 circular hole; and 12—spring.

### DESCRIPTION OF EMBODIMENTS

The present disclosure is illustrated in detail below in conjunction with the drawings and embodiments.

### Embodiment 1

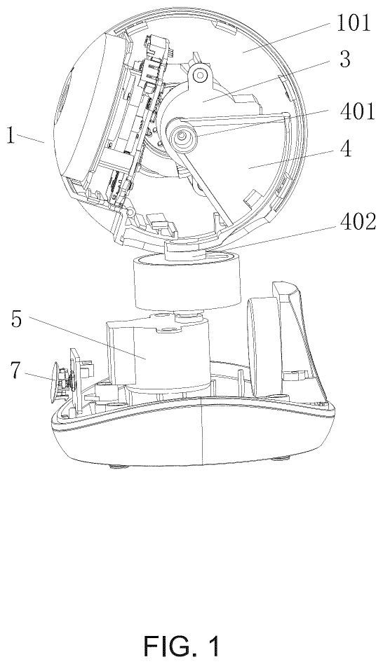

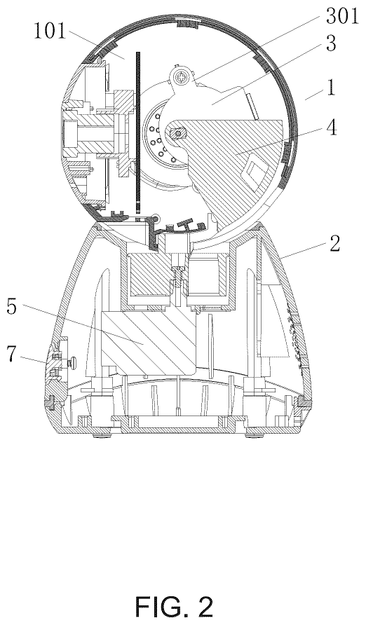

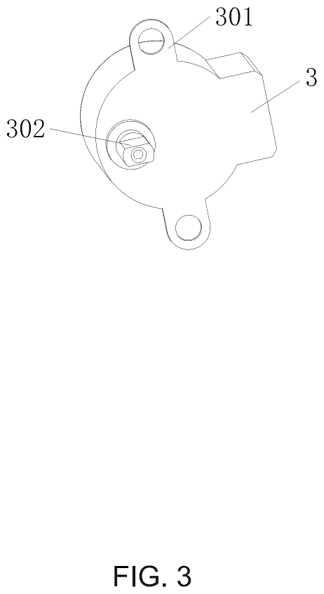

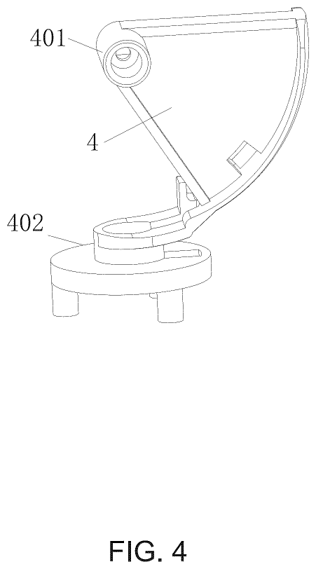

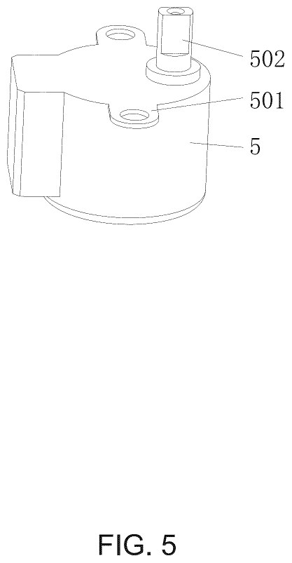

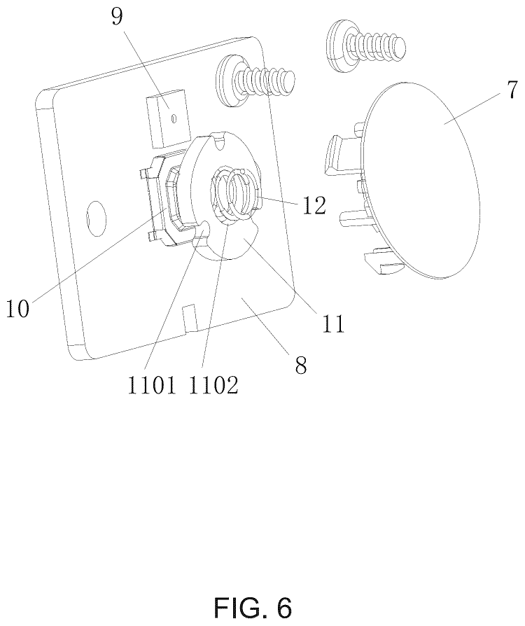

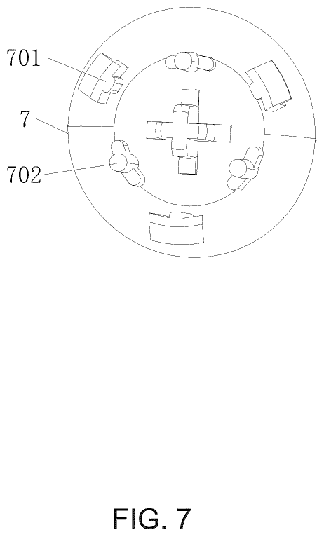

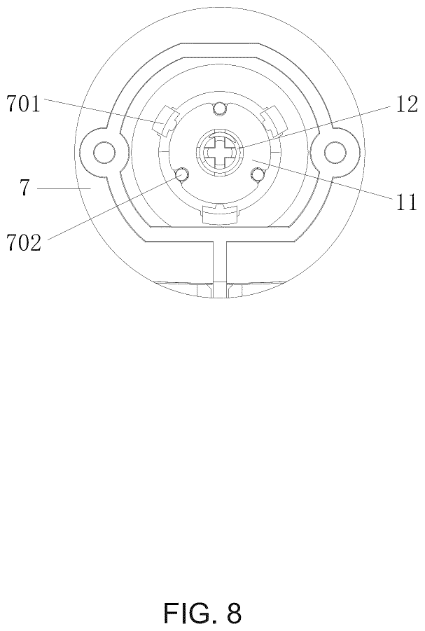

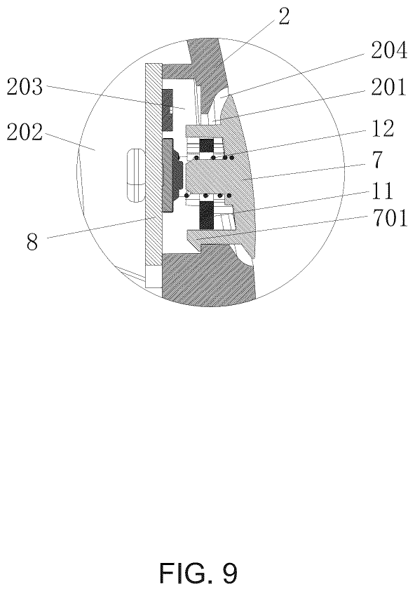

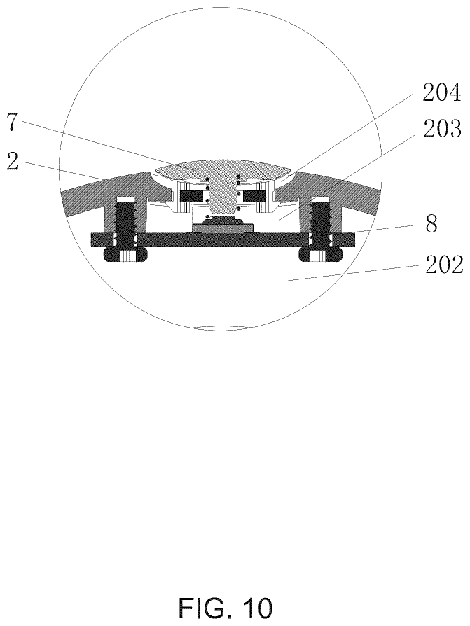

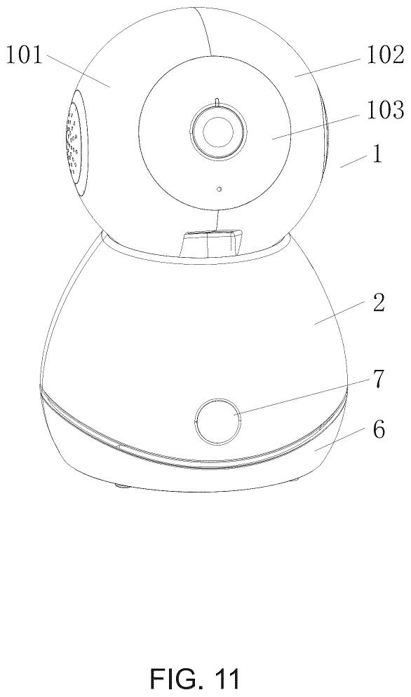

A hidden bidirectional rotary camera with a temperature and humidity sensing function, as shown in FIG. 1 to FIG. 11, includes a ball-head shell 1; a vertical stepping motor 3 and a motor bracket 4 are arranged in the ball-head shell 1; the ball-head shell 1 includes a left shell 101 and a right shell 102, and the left shell 101 is connected to the right shell 102; a first ear pad 301 and a first motor shaft 302 are arranged on the vertical stepping motor 3; the first ear pad 301 is fixed to the left shell 101 through two pan head screws; a vertical shaft sleeve 401 is arranged on the motor bracket 4; the first motor shaft 302 is fixedly connected to the vertical shaft sleeve 401 through a machine screw; the hidden bidirectional rotary camera further includes a base shell 2; the ball-head shell 1 is arranged on the upper side of the base shell 2; a horizontal stepping motor 5 is arranged in the base shell 2; a second ear pad 501 and a second motor shaft 502 are arranged on the horizontal stepping motor 5; the second ear pad 501 is fixed to the base shell 2 through two pan head screws; a horizontal shaft sleeve 402 is further arranged at the bottom of the motor bracket 4; and the second motor shaft 502) is fixedly connected to the horizontal shaft sleeve 402 through a machine screw.

A key hole 201 is formed in the bottom of the base shell 2; a key shell 7 is arranged in the key hole 201; the key shell 7 is connected to the base shell 2; a key PCB 8 is arranged at the key hole 201 in the base shell 2; the key PCB 8 is fixed to the base shell 2 through two self-tapping screws; and a temperature and humidity sensor 9 and a key electronic component 10 are arranged on one surface, facing the key hole 201, of the key PCB 8. The key PCB 8 is fixed through the self-tapping screws to close a device cavity into two parts, and an internal cavity of a device is isolated from an external air cavity into two parts, so that the influence of air temperature and humidity of the internal cavity of the device on the sensing judgment of the temperature and humidity sensor 9 is avoided.

Key shell buckles 701 and key positioning columns 702 are arranged on the key shell 7; the key positioning columns 702 are positioned on the inner side of the key shell buckles 701; the key shell 7 is connected to the base shell 2 through the key shell buckles 701; a key baffle 11 is arranged in the key shell 7; the key baffle 11 is inserted into the key shell 7 through the key positioning columns 702; and the key baffle 11 abuts against the key shell buckles 701. The key shell buckles 701 on the key shell 7 are fixed to a shell body, and the key baffle 11 is inserted into the key shell 7 by guiding the key positioning columns 702 and simultaneously abuts against three key shell buckles 701, so that the buckles cannot deform and retreat, and then keys are fixed to the shell body and cannot be easily pulled outwards to fall off.

Grooves 1101 are formed in the outer wall of the key baffle 11, and the key baffle 11 is inserted into the key positioning column 702 through the grooves 1101.

A circular hole 1102 is formed in the center of the key baffle 11; a spring 12 is arranged in the center of the key shell 7 in a sleeving manner; and one end of the spring 12 abuts against the key shell 7, and the other end of the spring 12 penetrates through the circular hole 1102 and abuts against the center of the key electronic component 10.

The key PCB 8 is positioned in the base shell 2 to form a closed cavity 202; a circulation cavity 203 is formed among the key PCB 8, the key shell 7 and the base shell 2; an air circulation channel 204 is formed between the key shell 7 and the hole wall of the key hole 201; and the circulation cavity 203 communicates with the air circulation channel 204. The air circulation channel 204 is formed in a gap between the key shell 7 and the shell body, so that the temperature and humidity sensor 9 in the cavity can sense the temperature and humidity of external air.

The ball-head shell 1 further includes a front shell 103, and the front shell 103 is connected to the left shell 101 and the right shell 102 through structural buckles.

The hidden bidirectional rotary camera further includes a base lower shell 6, and the base lower shell 6 is fixedly connected to the base shell 2 through screws.

Working principle: The vertical stepping motor 3 is fixed to the left shell 101 of the ball-head shell 1 of the camera with two pan head screws; meanwhile, the first motor shaft 302 is fixed to the motor bracket 4 with one machine screw; the first motor shaft 302 is driven to rotate to form a counter-acting force, so as to drive the ball-head to rotate in the vertical direction; the horizontal stepping motor 5 is fixed to the base shell 2 of the camera with the two pan head screws; meanwhile, the second motor shaft 502 is fixed to the motor bracket 4 by one machine screw; and the second motor shaft 502 is driven to rotate to form an acting force, so as to drive the ball-head and the motor bracket 4 to rotate in the horizontal direction.

Vertical rotation of the ball-head shell 1 of the camera: A user sends a rotation instruction to the vertical stepping motor 3 through an APP; after the vertical stepping motor 3 acquires the instruction, the first motor shaft 302 of the vertical stepping motor 3 is outputted to rotate; and the vertical stepping motor 3 is fixed to the left shell 101 of the ball-head shell 1 of the camera, so the first motor shaft 302 is fixed to a vertical shaft sleeve 401 of the motor bracket 4 through the machine screw. The motor bracket 4 is fixed with the second motor shaft 502 of the horizontal stepping motor 5, and cannot rotate in the vertical direction, so under the counter-acting force of the first motor shaft 302 of the vertical stepping motor 3, the left shell 101 of the ball-head shell 1 of the camera is driven to rotate in the vertical direction; and because the left shell 101 of the ball-head shell 1 of the camera is a part of the ball-head shell 1 of the camera, the ball-head shell 1 of the whole camera is driven to rotate vertically.

Horizontal rotation of the ball-head shell 1 of the camera: A user sends a rotation instruction to the horizontal stepping motor 5 through an APP; after the horizontal stepping motor 5 acquires the instruction, the second motor shaft 502 of the horizontal stepping motor 5 is outputted to rotate; and the horizontal stepping motor 5 is fixed to the base shell 2 of the camera, so the second motor shaft 502 is fixed to the horizontal shaft sleeve 402 of the motor bracket 4 through the machine screw. The motor bracket 4 is also fixed with the first motor shaft 302 of the vertical stepping motor 3, and the vertical stepping motor 3 is fixed to the left shell 101 of the ball-head shell 1 of the camera, so the second motor shaft 502 directly drives the motor bracket 4 and the ball-head shell 1 of the camera to rotate horizontally together.

The air circulation channel 204 is formed in a gap between the key shell 7 and the shell body, so that the temperature and humidity sensor 9 in the cavity can sense the temperature and humidity of external air; the key PCB 8 is fixed through the self-tapping screws to close a device cavity into two parts, and an internal cavity of a device is isolated from an external air cavity into two parts, so that the influence of air temperature and humidity of the internal cavity of the device on the sensing judgment of the temperature and humidity sensor 9 is avoided; the key shell buckles 701 on the key shell 7 are fixed to the shell body, the spring 12 is arranged in the middle in a sleeving manner, and the key baffle 11 is inserted into the key shell 7 by guiding the key positioning columns 702 and simultaneously abuts against three key shell buckles 701, so that the buckles cannot deform and retreat, and then keys are fixed to the shell body and cannot be easily pulled outwards to fall off; and meanwhile, the spring 12 provides elastic force for the stroke motion of the key shell 7.

According to the present disclosure, the vertical and horizontal rotary motions of a ball-head part of the camera are realized through the motor bracket, and a temperature and humidity sensing structure is hidden in a key structure, so the temperature and humidity of external air can be sensed; and moreover, the shape of the camera is not limited, so the hidden bidirectional rotary camera is more diversified, is fixed reliably, and is convenient to process, and the manufacturing cost is reduced.

### Embodiment 2

A hidden bidirectional rotary camera with a temperature and humidity sensing function, as shown in FIG. 1 to FIG. 5, includes a ball-head shell 1; a vertical stepping motor 3 and a motor bracket 4 are arranged in the ball-head shell 1; the ball-head shell 1 includes a left shell 101 and a right shell 102, and the left shell 101 is connected to the right shell 102; a first ear pad 301 and a first motor shaft 302 are arranged on the vertical stepping motor 3; the first ear pad 301 is fixed to the left shell 101 through two pan head screws; a vertical shaft sleeve 401 is arranged on the motor bracket 4; the first motor shaft 302 is fixedly connected to the vertical shaft sleeve 401 through a machine screw; the hidden bidirectional rotary camera further includes a base shell 2; the ball-head shell 1 is arranged on the upper side of the base shell 2; a horizontal stepping motor 5 is arranged in the base shell 2; a second ear pad 501 and a second motor shaft 502 are arranged on the horizontal stepping motor 5; the second ear pad 501 is fixed to the base shell 2 through two pan head screws; a horizontal shaft sleeve 402 is further arranged at the bottom of the motor bracket 4; and the second motor shaft 502) is fixedly connected to the horizontal shaft sleeve 402 through a machine screw.

### Embodiment 3

A hidden bidirectional rotary camera with a temperature and humidity sensing function, as shown in FIG. 1 to FIG. 10, includes a ball-head shell 1; a vertical stepping motor 3 and a motor bracket 4 are arranged in the ball-head shell 1; the ball-head shell 1 includes a left shell 101 and a right shell 102, and the left shell 101 is connected to the right shell 102; a first ear pad 301 and a first motor shaft 302 are arranged on the vertical stepping motor 3; the first ear pad 301 is fixed to the left shell 101 through two pan head screws; a vertical shaft sleeve 401 is arranged on the motor bracket 4; the first motor shaft 302 is fixedly connected to the vertical shaft sleeve 401 through a machine screw; the hidden bidirectional rotary camera further includes a base shell 2; the ball-head shell 1 is arranged on the upper side of the base shell 2; a horizontal stepping motor 5 is arranged in the base shell 2; a second ear pad 501 and a second motor shaft 502 are arranged on the horizontal stepping motor 5; the second ear pad 501 is fixed to the base shell 2 through two pan head screws; a horizontal shaft sleeve 402 is further arranged at the bottom of the motor bracket 4; and the second motor shaft 502 is fixedly connected to the horizontal shaft sleeve 402 through a machine screw.

A key hole 201 is formed in the bottom of the base shell 2; a key shell 7 is arranged in the key hole 201; the key shell 7 is connected to the base shell 2; a key PCB 8 is arranged at the key hole 201 in the base shell 2; the key PCB 8 is fixed to the base shell 2 through two self-tapping screws; and a temperature and humidity sensor 9 and a key electronic component 10 are arranged on one surface, facing the key hole 201, of the key PCB 8. The key PCB 8 is fixed through the self-tapping screws to close a device cavity into two parts, and an internal cavity of a device is isolated from an external air cavity into two parts, so that the influence of air temperature and humidity of the internal cavity of the device on the sensing judgment of the temperature and humidity sensor 9 is avoided.

Key shell buckles 701 and key positioning columns 702 are arranged on the key shell 7; the key positioning columns 702 are positioned on the inner side of the key shell buckles 701; the key shell 7 is connected to the base shell 2 through the key shell buckles 701; a key baffle 11 is arranged in the key shell 7; the key baffle 11 is inserted into the key shell 7 through the key positioning columns 702; and the key baffle 11 abuts against the key shell buckles 701. The key shell buckles 701 on the key shell 7 are fixed to a shell body, and the key baffle 11 is inserted into the key shell 7 by guiding the key positioning columns 702 and simultaneously abuts against three key shell buckles 701, so that the buckles cannot deform and retreat, and then keys are fixed to the shell body and cannot be easily pulled outwards to fall off.

Grooves 1101 are formed in the outer wall of the key baffle 11, and the key baffle 11 is inserted into the key positioning column 702 through the grooves 1101.

A circular hole 1102 is formed in the center of the key baffle 11; a spring 12 is arranged in the center of the key shell 7 in a sleeving manner; and one end of the spring 12 abuts against the key shell 7, and the other end of the spring 12 penetrates through the circular hole 1102 and abuts against the center of the key electronic component 10.

The key PCB 8 is positioned in the base shell 2 to form a closed cavity 202; a circulation cavity 203 is formed among the key PCB 8, the key shell 7 and the base shell 2; an air circulation channel 204 is formed between the key shell 7 and the hole wall of the key hole 201; and the circulation cavity 203 communicates with the air circulation channel 204. The air circulation channel 204 is formed in a gap between the key shell 7 and the shell body, so that the temperature and humidity sensor 9 in the cavity can sense the temperature and humidity of external air.

What is claimed is:

1. A hidden bidirectional rotary camera with a temperature and humidity sensing function, comprising a ball-head shell (1), wherein a vertical stepping motor (3) and a motor bracket (4) are arranged in the ball-head shell (1); the ball-head shell (1) comprises a left shell (101) and a right shell (102), and the left shell (101) is connected to the right shell (102); a first ear pad (301) and a first motor shaft (302) are arranged on the vertical stepping motor (3); the first ear pad (301) is fixed to the left shell (101) through two pan head screws; a vertical shaft sleeve (401) is arranged on the motor bracket (4); the first motor shaft (302) is fixedly connected to the vertical shaft sleeve (401) through a machine screw; the hidden bidirectional rotary camera further comprises a base shell (2); the ball-head shell (1) is arranged on the upper side of the base shell (2); a horizontal stepping motor (5) is arranged in the base shell (2); a second ear pad (501) and a second motor shaft (502) are arranged on the horizontal stepping motor (5); the second ear pad (501) is fixed to the base shell (2) through two pan head screws; a horizontal shaft sleeve (402) is further arranged at the bottom of the motor bracket (4); and the second motor shaft (502) is fixedly connected to the horizontal shaft sleeve (402) through a machine screw.

2. The hidden bidirectional rotary camera with the temperature and humidity sensing function according to claim 1, wherein a key hole (201) is formed in the bottom of the base shell (2); a key shell (7) is arranged in the key hole (201); the key shell (7) is connected to the base shell (2); a key PCB (8) is arranged at the key hole (201) in the base shell (2); the key PCB (8) is fixed to the base shell (2) through two self-tapping screws; and a temperature and humidity sensor (9) and a key electronic component (10) are arranged on one surface, facing the key hole (201), of the key PCB (8).

3. The hidden bidirectional rotary camera with the temperature and humidity sensing function according to claim 2, wherein key shell buckles (701) and key positioning columns (702) are arranged on the key shell (7); the key positioning columns (702) are positioned on the inner side of the key shell buckles (701); the key shell (7) is connected to the base shell (2) through the key shell buckles (701); a key baffle (11) is arranged in the key shell (7); the key baffle (11) is inserted into the key shell (7) through the key positioning columns (702); and the key baffle (11) abuts against the key shell buckles (701).

4. The hidden bidirectional rotary camera with the temperature and humidity sensing function according to claim 3, wherein grooves (1101) are formed on the outer wall of the key baffle (11), and the key baffle (11) is inserted into the key positioning column (702) through the grooves (1101).

5. The hidden bidirectional rotary camera with the temperature and humidity sensing function according to claim 3, wherein a circular hole (1102) is formed in the center of the key baffle (11); a spring (12) is arranged in the center of the key shell (7) in a sleeving manner; and one end of the spring (12) abuts against the key shell (7), and the other end of the spring (12) penetrates through the circular hole (1102) and abuts against the center of the key electronic component (10).

6. The hidden bidirectional rotary camera with the temperature and humidity sensing function according to claim 2, wherein the key PCB (8) is positioned in the base shell (2) to form a closed cavity (202); a circulation cavity (203) is formed among the key PCB (8), the key shell (7) and the base shell (2); an air circulation channel (204) is formed between the key shell (7) and the hole wall of the key hole (201); and the circulation cavity (203) communicates with the air circulation channel (204).

7. The hidden bidirectional rotary camera with the temperature and humidity sensing function according to claim 1, wherein the ball-head shell (1) further comprises a front shell (103), and the front shell (103) is connected to the left shell (101) and the right shell (102) through structural buckles.

8. The hidden bidirectional rotary camera with the temperature and humidity sensing function according to claim 1, wherein the hidden bidirectional rotary camera further comprises a base lower shell (6), and the base lower shell (6) is fixedly connected to the base shell (2) through screws.
